(19) United States
(12) Patent Application Publication
(10) Pub. No.: US 2012/0288672 A1
(43) Pub. Date: Nov. 15, 2012

(54) SOLVENT VAPOR BONDING AND SURFACE TREATMENT METHODS

(76) Inventors: Iain Rodney George Ogilvie, Southampton (GB); Cedric Florian Aymeric Floquet, Southampton (GB); Hywel Morgan, (US); Vincent Joseph Sieben, Victoria (CA); Matthew Charles Mowlem, Westbourne (GB)

(21) Appl. No.: 13/106,488

(22) Filed: May 12, 2011

(51) Int. Cl. B32B 3/00; B32B 37/14; B29C 65/00; B32B 37/02

(52) U.S. Cl. 428/141; 216/34; 216/58

(57) ABSTRACT

The present invention relates to a method of producing a microstructured device, as well as a method of processing a microstructured substrate to heal surface defects therein, a method of bonding substrates and healing surface defects in a substrate, and microstructured devices produced by these methods.

### FIELD OF THE INVENTION

This invention relates to methods of surface treatment and bonding of microstructured substrates using solvent vapour.

### BACKGROUND TO THE INVENTION

Microfluidic devices are useful tools for the analysis of a variety of fluids, including chemical and biological fluids. These devices are primarily composed of microfluidic channels—for example input and output channels, plus structured areas for sample diagnosis. For effective processing of the fluid by the device, the fluid controllably passes through these channels.

Various types of microfluidic devices are known. The channel cross-section dimensions in a microfluidic device can vary widely, but may be anything from the millimeter scale to the nanometer scale. Reference to microfluidics in this document is not restricted to micrometer scale devices, but includes both larger (millimeter) and smaller (nanometer) scale devices as is usual in the art.

A basic form of a microfluidic device is based on continuous flow of the relevant fluids through the channels.

Microfluidic lab-on-a-chip (LOC) platforms^{1,2} show considerable promise for the creation of robust miniaturized, high performance metrology systems with applications in diverse fields such as environmental analysis^{3,4} potable and waste water, point of care diagnostics and many other physical, chemical and biological analyses. The technology allows the integration of many components and subsystems (e.g. fluidic control, mixers, lenses, light sources and detectors) in small footprint devices that could potentially be mass produced. Reduction in size enables reduction in power and reagent consumption making miniaturization of a complete sensing system feasible. There are many applications to this technology, particularly in the development of remote in situ sensing systems for environmental analysis, and one area of importance is the measurement of ocean biogeochemistry.

Long term, coherent and synoptic observations of biogeochemical processes are of critical relevance for interpretation and prediction of the oceans (and hence the earth's) response to elevated CO₂ concentrations and climate change. Observations of oceanographic biogeochemical parameters are used to constrain biogeochemical models and understanding⁵⁻⁷ that in turn informs modeling of the ocean⁸ and earth system⁹. A promising approach for obtaining oceanographic biogeochemical data on enhanced spatial and temporal scales is to add biogeochemical sensors to existing networks of profiling floats or vehicles¹⁰. For long-term deployments these sensors should have high resolution and accuracy, negligible buoyancy change, low consumption of power and/or chemical reagents, and be physically small.

Colorimetric assays for determination of inorganic chemical concentrations (e.g. Nitrate/Nitrite¹¹, Phosphate¹², Iron¹³ and Manganese¹⁴) have long providence and are used widely in oceanography. Applied in laboratory¹⁵, shipboard¹⁶, and in situ analysis¹⁷⁻¹⁹ (i.e. in a submerged analytical system) they enable measurements over a wide measurement range including at low open ocean concentrations²⁰.

Microfluidic devices may be made from a variety of substrate materials, including thermoplastic, glass and crystal.

In thermoplastic microfluidic devices, the channels can be formed by a variety of means, including hot embossing²¹⁻²⁶, casting and injection moulding²⁷, direct write processes such as wax printer prototyping²⁸ and stereolithography²⁹, powder blasting, laser and mechanical micromachining³⁰⁻³², and dry film laminating³³.

Techniques such as hot embossing, casting and injection molding typically are able to produce high quality devices with optical quality surfaces. However, these methods require masters (often made from SU8 or Si/Ni) that are fabricated in cleanrooms.

Injection molding requires a precision metal master, which is expensive and unsuited to rapid-prototyping²⁴. Wax printing produces a poor surface finish and low aspect ratio devices²⁸.

Novel materials such as polystyrene (Shrinkydinks) have also been used to create microfluidic chips³⁴ although with poor dimensional accuracy caused by shrinking of the substrates. Stereolithography has been used to produce microfluidic devices and microsensor packages²⁹, where structures are created by curing a liquid resin with a laser; but surface roughness is often on the micrometer scale.

Therefore, many of the current rapid prototyping techniques show promise for low-cost realization of microfluidic designs, but they often compromise optical quality, are not cost-effective or retain some dependence on clean room facilities.

Chemically robust, low-cost and biocompatible thermopolymers with good optical properties, such as polymethyl methacrylate (PMMA) and cyclic olefin copolymer (COC), are frequently used in microfluidic applications.

Some of the techniques mentioned above can be used to create microfluidic channels in these polymers. Hot embossing and injection molding are capable of yielding high-quality surfaces, where the surface roughness can be of the order of 10 nm³⁵.

Alternatively, micromilling is a relatively simple technique, which can produce microfluidic channel features down to 50 μm, sufficient for many microfluidic applications^{30,32,36}. The design-to-chip cycle is fast, typically a few hours, and the method has low running cost (˜$40/hr). As with most milling methods, it is able to produce 3D structures (often difficult with optical lithography techniques³⁷), and a wide range of materials can be processed including most polymers and even stainless steel²⁵.

Despite these advantages over other micro-fabrication techniques, the surface roughness obtained by micromilling is generally quite poor (in the hundreds of nanometers³⁸) and is significantly below what is needed for optical grade material.

After a surface of a substrate has been microstructured with microfluidic channel features a further substrate, typically with an unstructured surface is bonded on top of the structured surface to fully form the microchannels. Various techniques⁵ are known for sealing such a “lid” substrate onto the microstructured substrate to close the microfluidic channels. Thus, a further substrate is effectively bonded to the initial substrate which includes the microfluidic channels.

Microfluidic devices can incorporate multiple layers of substrates. In this way, single microfluidic devices can be provided with multiple microfluidic channel configurations.

The techniques used to bond the substrates together vary in their efficiency and effectiveness. Thermal bonding can be used^{40,41}, but this typically produces a relatively weak bond (<1 MPa). Surface treatment or adhesive may used⁴²⁻⁴⁴ to improve the bond strength; for example, dissimilar polymer layers can be used for bonding with microwave welding⁵². However, such methods add extra processing steps and complexity.

Bonding techniques involving solvent bonding are known in the art to provide an alternative method of sealing devices. In the solvent bonding techniques of the art⁴⁶, each substrate is immersed in an 80:20% mix of ethanol and decalin for 15 minutes at 21° C. This results in the surface layer of the substrate being softened by direct exposure to the liquid solvent. The two halves are brought into contact and when the solvent evaporates the substrates are bonded. However, application of the solvent in a controlled manner is key to producing a uniform and strong bond. Where this is not adequately done, channel collapse occurs^{47,48}. The liquid solvent can be introduced through capillary action⁴⁹, soaked into the surface^{47,48,50-56} or applied through a vapour⁵⁷⁻⁵⁹.

As mentioned above, channel collapse is a frequent problem^{47,61}. Channel collapse can also be caused by overexposure to solvent, excessive heat during bonding, overpressure or non-uniformities in the applied pressure^{48,51}. Channel collapse can be avoided in a number of ways including filling channels with ice⁴⁷, wax⁵³ or optimization of solvent exposure time⁵¹. However, such steps are disadvantageous as they introduce additional steps into the fabrication process.

### SUMMARY OF INVENTION

In one aspect, the present invention provides a method of making a microstructured device comprising the steps of:
i) providing a first substrate with a first bonding surface and a second substrate with a second bonding surface, wherein at least one of the bonding surfaces is formed with microstructured features;
ii) exposing at least one of the bonding surfaces to solvent vapor for a period of at least about 220 seconds;
iii) bringing the first and second bonding surfaces into contact; and
iv) applying pressure to the substrates to urge the first and second bonding surfaces together to bond together the first and second substrates and thereby form the microstructured device.

In another aspect, the invention provides a method of processing a microstructured substrate to heal surface defects therein, comprising the step of:
i) providing a substrate having a surface bearing microstructured features;
ii) exposing said surface to solvent vapor for a period of time sufficient to heal defects in the surface while preserving the microstructured features.

In a further aspect, the invention provides a method of making a microstructured device comprising the steps of:
i) providing a first substrate with a first bonding surface and a second substrate with a second bonding surface, wherein at least one of the bonding surfaces is formed with microstructured features;
ii) exposing at least one of the bonding surfaces to solvent vapor for a period of time sufficient to heal defects in the surface while preserving the microstructured features.;
iii) bringing the first and second bonding surfaces into contact; and
iv) applying pressure to the substrates to urge the first and second bonding surfaces together to bond together the first and second substrates and thereby form the microstructured device.

The first substrate and/or the second substrate may be made of a thermoplastic polymer, which may be either the same thermoplastic polymer or different ones.

The thermoplastic polymer of the first and/or second substrate can be selected from the group consisting of polyethylenes; polypropylenes; poly(1-butene); poly(methyl pentene); poly(vinyl chloride); poly(acrylonitrile); poly(tetrafluoroethylene) (PTFE-Teflon®), poly(vinyl acetate); polystyrene; poly(methyl methacrylate) (PMMA); ethylene-vinyl acetate copolymer; ethylene methyl acrylate copolymer; styrene-acrylonitrile copolymers; cycloolefin polymers and copolymers (COC); and mixtures and derivatives thereof.

The thermoplastic polymer of the first and/or second substrate can be poly(methyl methacrylate) and/or COC.

The first and second substrates can be formed from the same material or from different materials.

The solvent vapor can be selected to be capable of solubilizing both the first and the second substrates.

The solvent vapour can be selected from the group consisting of toluene, trichloroethylene, carbon tetrachloride, chlorobenzene, chloroform, cyclohexane, benzene, o-dichlorobenzene, butyl acetate, methyl isobutyl ketone, methylene dichloride, ethylene dichloride, 1,1-dichloroethane, isopentylacetate, hexane, ethyl acetate, diethyl ether, 1,4-doxane, tetrahydrofuran, acetophenone, isophorone, nitrobenzene, 2-nitropropane, acetone, diacetone alcohol, methyl-2-pyrrolidone ethylene glycol monobutyl ether, cyclohexanol, nitroethane, ethylene glycol monoethyl ether, dimethylformamide, 1-butanol, γ-butyrolactone, ethylene glycol monomethyl ether, dimethyl sulfoxide, propylene carbonate, nitromethane, dipropylene glycol, ethanol, diethylene glycol, propylene glycol, methanol, ethanolamine, ethylene glycol, formamide, methylcyclohexane, decalin, water and combinations thereof.

The first substrate and/or the second substrate can be formed from poly(methyl methacrylate) when the solvent vapor is chloroform.

The first substrate and/or the second substrate can be formed from COC when the solvent vapor is cyclohexane.

The substrate or substrates can be exposed to the solvent vapor for a period of time in the range of about 220 seconds to about 280 seconds, for example about 240 seconds.

The microstructured features, which can include microfluidic channel features, can be formed in the first and/or second substrates by a method selected from hot embossing, casting and injection molding, direct write processes such as wax printer prototyping and stereolithography, powder blasting, micromilling, and dry film laminating.

For example, the microstructured features can be formed by micromilling.

For example, the surface bearing the microfluidic channel features or other microstructured features can have a surface roughness in the region of 50 nm to 250 nm before exposure to the solvent vapor, which reduces to less than 25 nm after exposure to the solvent vapor, or less than 15 nm.

In a further aspect, the present invention provides a microfluidic device produced according to the methods described herein.

### BRIEF DESCRIPTION OF THE DRAWINGS

The invention is now described by way of example only with reference to the following drawings.

FIG. 1(A) shows a schematic of the solvent vapor bonding process. FIG. 1(B) shows a picture of a PMMA solvent vapor bonded chip.

FIG. 2 shows an scanning electron micrograph (SEM) of a microfluidic channel milled in PMMA and COC immediately after machining, showing the typical quality obtained with a micro-mill. FIGS. 2(A and C) show SEMs of the surfaces before treatment with solvent vapor. FIGS. 2(B and D) show SEMs of the surfaces after treatment with solvent vapor.

FIG. 3 summarizes the atomic force microscope (AFM) surface roughness data depicted in FIG. 2. Graph units are in micrometers.

FIG. 4 shows an example of the channel cross-section for a PMMA solvent vapor bonded chip. The channels are the same dimensions as in FIG. 2, 250 μm wide and 200 μm deep. FIGS. 5(A)-(D) shows a summary of the force as a function of time of exposure to solvent (at 140 N/cm2) and pressure (for 4 minutes exposure) during bonding for PMMA and COC substrates respectively.

FIGS. 6(A) and 6(B) show photographs of light scattering through a milled PMMA microchip with a cylindrical lens before and after exposure to solvent vapor. FIG. 6(A) shows the microchip after micro-milling and before solvent vapor treatment; the lens is ineffective as shown by the degree of light scattering at the interfaces and the degradation of the beam profile across the channel. FIG. 6(B) shows the improvement of the lens performance after solvent vapor treatment.

### DETAILED DESCRIPTION

Definitions

“Microstructured features” refers to features formed on the surface of a substrate which enable that substrate to be employed in microfluidic applications. In this regard, one example of a microstructured feature is a microfluidic channel.

In this specification “alkyl” denotes a straight- or branched-chain, saturated, aliphatic hydrocarbon radical. Preferably, said “alkyl” consists of 1 to 12, typically 1 to 8, suitably 1 to 6 carbon atoms. A C₁₋₆ alkyl group includes methyl, ethyl, propyl, isopropyl, butyl, t-butyl, 2-butyl, pentyl, hexyl, and the like. The alkyl group may be substituted where indicated herein.

“Cycloalkyl” denotes a cyclic, saturated, aliphatic hydrocarbon radical. Examples of cycloalkyl groups are moieties having 3 to 10, preferably 3 to 8 carbon atoms including cyclopropyl, cyclobutyl, cyclopentyl, cyclohexyl and cyclooctyl groups. The cycloalkyl group may be substituted where indicated herein.

“Alkoxy” means the radical “alkyl-O—”, wherein “alkyl” is as defined above, either in its broadest aspect or a preferred aspect.

“Phenyl” means the radical —C₆H₅. The phenyl group may be substituted where indicated herein.

“Hydroxy” means the radical —OH.

“Halo” means a radical selected from fluoro, chloro, bromo, or iodo.

“Nitro” means the radical —NO₂.

Solvent Vapor Bonding

The present invention relates to a method of bonding two or more substrates via solvent vapor bonding.

Without wishing to be bound by theory, it is understood that upon exposure to an appropriate solvent, the surface of the substrate which is to be bonded is solubilized by the solvent. This solubilization leads to a softening of the substrate surface. Upon contact with the surface of the second substrate to be bonded, the polymer chains of the two surfaces interdiffuse.

Upon subsequent evaporation of the solvent and hardening of the surfaces, the polymer chains become fixed and the two surfaces are bonded together.

Guarding against channel collapse when solvent bonding microstructured substrates is an important consideration²⁶. Channel collapse can result due to over exposure of the surface of the substrate to the solvent. Many of the methods of the art which have used direct solvent application have sought to protect the microfluidic channels through the use of sacrificial wax or water protectants.

Additionally, by using solvent vapor to solubilize the surface of the substrate, a thin layer of the substrate is softened. This is advantageous in that in can reduce potential damage of the microfluidic device when subjected to pressure during bonding. As will be appreciated, any imperfections in a relatively hard surface will be amplified during bonding as they will “stand out” against the surface of the other substrate. These imperfections can thus lead to a lack of uniform pressure being applied across the substrates to be bonded and can lead to bonds which are less effective. By softening the surface of the substrate which is to be bonded, these imperfections in the original substrate can be tolerated to a greater degree and thus a more reliable bond can be created. It is also important to note that in the present invention only the external of the substrate is softened to any significant degree as opposed to thermally heating the substrate, where the whole structure is softened.

It has been found by the present inventors that microfluidic channel collapse can be inhibited by using solvent vapor to solubilize the surface layer of the substrate. Furthermore, it has been found that the exposure time of the surface to the solvent vapor can be optimized so as to enhance substrate bonding.

In one embodiment, the substrate is exposed to the solvent vapor for a period of time long enough to effect successful bonding but short enough to ensure that microfluidic channel collapse, or degradation of other microstructured surface features, does not occur.

In one embodiment, the substrate is exposed to the solvent vapor for a period of time of at least about 220 seconds. It has been surprisingly found that exposing the substrate to solvent vapour for a period of time of least about 220 seconds provides a surface which can form a sufficiently strong bond with the other substrate surface, yet which does not diminish the functional integrity of any microstructured features present on the substrate surface. Also, exposing the surface to solvent vapour for periods of time significantly less than 220 seconds can lead to a lack of bond uniformity across the substrate surface. Thus, a solvent exposure time of at least about 220 seconds is advantageous.

It has also been found that a solvent vapour exposure time of up to about 10 minutes can be tolerated for some solvents/solvent mixtures. Exposing the substrates to solvent vapour for periods of time longer than 10 minutes has a negative effect on the integrity of the microstructured surface features. Also, it is considered that a maximum solvent vapour exposure time of about 10 minutes is preferable from a commercial view point.

In one embodiment, the substrate is exposed to the solvent vapor for a period of time in the range of about 220 seconds to about ten minutes. In one embodiment, the substrate is exposed to the solvent vapor for a period of time in the range of about 220 seconds to about 360 seconds. In one embodiment, the substrate is exposed to the solvent vapor for a period of time in the range of about 220 seconds to about 280 seconds. In one embodiment, the substrate is exposed to the solvent vapor for a period of time in the range of about 220 seconds to about 260 seconds. In one embodiment, the substrate is exposed to the solvent vapor for a period of time in the range of about 220 seconds to about 255 seconds. In one embodiment, the substrate is exposed to the solvent vapor for a period of time in the range of about 220 seconds to about 250 seconds. In one embodiment, the substrate is exposed to the solvent vapor for a period of time in the range of about 230 seconds to about 245 seconds. In one embodiment, the substrate is exposed to the solvent vapor for a period of time in the range of about 235 seconds to about 245 seconds. In one embodiment, the substrate is exposed to the solvent vapor for about 240 seconds.

It is preferable that the exposure of the substrate to the solvent vapor is conducted in a controlled environment, preferably an enclosed environment. By controlled environment it is meant that the temperature of the environment surrounding the solvent source and substrate is controlled.

By enclosed environment, it is meant that the substrate and the solvent vapor source are not open to the general atmosphere but enclosed in a chamber or the like. This could be achieved, for example, by arranging the substrate and the solvent vapor source as described in the below examples.

In one embodiment, the substrate is placed above a source of the solvent and both the substrate and solvent source are enclosed in a chamber so as to contain the solvent vapor produced from the solvent source. In one embodiment, the solvent source is comprised of a container which contains the solvent. In one embodiment, the solvent source is a substrate including a layer of the solvent on its surface. In one embodiment, a substrate which does not contain any microfluidic channel features is the source of the solvent vapor.

The temperature of the solvent vapor environment is typically controlled such that it is around 25° C. Increased temperatures or exposure to direct sunlight can lead to increased evaporation of the solvent and possible overexposure of the substrate surface.

In one embodiment, the substrate is exposed to the solvent source under conditions which allow for the surface of the substrate to be solubilized by the solvent vapor.

In one embodiment, the substrate is exposed to the solvent source such that there is a distance of at most about 5 mm from the top of the solvent source to the substrate surface which is to be solubilized. In one embodiment, the substrate is exposed to the solvent source such that there is a distance of at most about 4 mm from the top of the solvent source to the substrate surface which is to be solubilized. In one embodiment, the substrate is exposed to the solvent source such that there is a distance of at most about 2 mm from the top of the solvent source to the substrate surface which is to be solubilized. In one embodiment, the substrate is exposed to the solvent source such that there is a distance of at most about 1 mm from the top of the solvent source to the substrate surface which is to be solubilized.

Following exposure to the solvent vapor, the exposed surface of the substrate is contacted with a surface of the other substrate which is to be bonded. As is typical in the art of microfluidic device fabrication, it may be necessary to position the two substrates relative to each other in an accurate manner, especially if both substrates are featured. This can be done through the use of semiconductor industry mask alignment equipment, conventional micropositioning equipment, conventional jigs etc.

Following alignment (if necessary) and contact of the two substrates, pressure is applied to the substrates. The pressure is to be applied in a direction perpendicular to the plane of the contacted surfaces of the substrates.

Bond pressure should be sufficiently high so as to provide for effective bonding, yet it should not be so high that microfluidic channel collapse results.

In one embodiment, the pressure applied to the substrates should not be greater than about 180 Ncm⁻². In one embodiment, the pressure applied to the substrates is greater than about 100 Ncm⁻². In one embodiment, the pressure applied to the substrates is greater than about 110 Ncm⁻². In one embodiment, the pressure applied to the substrates is greater than about 120 Ncm⁻². In one embodiment, the pressure applied to the substrates is greater than about 130 Ncm⁻². In one embodiment, the pressure applied to the substrates is about 140 Ncm⁻². In one embodiment, the pressure applied to the substrates is about 150 Ncm⁻². In one embodiment, the pressure applied to the substrates is about 160 Ncm⁻².

Bond strength of the two substrates is measured from the peak peel force required for delamination. This can be determined using an ASTM D1876 T-Peel test using an Instron 5569 tensile testing machine (Instron, Buckinghamshire, UK⁶⁷).

It is typically considered that bonded substrates with a peak peel force of 0.4 Nmm⁻¹ and above are bonded with sufficient strength for a number of commercial applications. Substrates with bonds having a greater peak peel force may be desirable in some applications. In some embodiments, the bonded substrate has a peak peal force of at least 2 Nmm⁻¹. In some embodiments, the bonded substrate has a peak peal force of at least 3 Nmm⁻¹.

Once the two substrates have been contacted, they may optionally be subjected to thermal treatment during the application of pressure, after the application of pressure or in a pressure/thermal cycle.

Thermal treatment of a polymer substrate such that its temperature approaches its glass transition temperature, T_{g}, will result in a softening of the substrate. The term “glass transition temperature” is used here with its normal meaning in the field of polymers as the temperature above which the polymer becomes rubbery, i.e. encounters an increase in its rate of change of specific volume with temperature. This softening allows for further additional polymer chain interaction and thus can contribute to the bond strength. In all cases, however, the bond temperature must be set below the glass transition temperature of the substrate to minimize the possibility of microfluidic channel collapse.

In one embodiment, the bonding temperature of a polymer substrate is set to at least 30% below the T_{g} of the substrate. In one embodiment, the bonding temperature of the substrate is set to at least 35% below the T_{g} of the substrate. In one embodiment, the bonding temperature of the substrate is set to at least 40% below the T_{g} of the substrate. For example, the T_{g} of poly(methyl methacrylate) polymer is 115° C. and the substrate bonding temperature is set to 65° C. (about 43% below the T_{g}).

In one embodiment, the bonded substrates are actively cooled after they have been subjected to thermal treatment. In one embodiment, the bonded substrates are cooled to room temperature (about 20-25° C.).

In one embodiment, only one of the two or more substrate to be bonded is directly exposed to solvent vapor. In an alternative embodiment, both substrates are exposed to the solvent vapor.

Further, it will be understood that microfluidic devices can contain multiple layers of substrates, with multiple layers of microfluidic channel features. Thus, in one embodiment, more than two substrates are bonded together. In one embodiment, three, four, five, six, seven, eight, nine or ten substrates are bonded together. In one embodiment, more than one of the substrates includes microfluidic channel features.

Where only one of the substrates is directly exposed to solvent vapor, the other substrate may be exposed to solvent vapor during the alignment of the two substrates.

Healing of Defects in Substrate Surface by Solvent Vapor

A number of methods commonly used for forming microfluidic channels in substrates can result in the channels have significant surface roughness. Low surface roughness, of the order of <15 nm, is important for the microfluidic channels to be of optical quality. For example, micromilling can lead to a channel surface roughness of 100-200 nm (measured using atomic force microscopy (AFM)).

Microfluidic channels with low levels of surface roughness may also be important in other, non-optical applications, such as molecular arrays and continuous flow microfluidics.

The present method of healing defects in the surface of the substrate while preserving the microstructured features therefore includes reducing the surface roughness of the microstructured features.

In one embodiment, reducing the surface roughness seeks to reduce the amount of microfluidic channel surface roughness after formation from non-optical quality to optical quality.

In one embodiment, the method of reducing surface roughness is capable of reducing the surface roughness of the microfluidic channel from around 200 nm to about 15 nm or less.

The controlled delivery and uptake of solvent to the surface containing the microstructured features is achieved by exposure to a solvent vapor atmosphere.

Without wishing to be bound by theory, the thin solvent-saturated surface layer causes reflow of the polymer and thereby smoothes out rough features. The use of solvent vapor addresses the problems of microfluidic channel collapse seen and reported in the art using direct application of liquid solvent. Indeed, direct application of liquid solvent to the substrate surface can actually lead to increased surface roughness. Lin et al.⁶¹ characterized the impact of solvent treatment on surface roughness after bonding PMMA by direct application of a liquid solvent to the substrate surface. The surface roughness of an embossed channel increased from 13.4 nm to 18 nm after coating the surface in solvent (20% (by weight) 1,2-dichloroethane and 80% ethanol). Thus, this direct liquid exposure method increased the surface roughness of the microfluidic channel features. By contrast, the solvent vapor exposure method presented herein reduces the surface roughness of the microstructured features without comprising their functional integrity.

Substrate

The substrates of the present invention are not particularly limited provided they are susceptible to solubilization by at least one known solvent. Examples of suitable substrates include thermoplastic organic polymers.

In one embodiment, the substrate is a thermoplastic organic polymer. Suitable thermoplastic organic polymers that can be used to provide the substrate include, but are not limited to, polyalkenes (polyolefins), polyamides (nylons), polyesters, polycarbonates, polyimides and mixtures thereof. The substrate may be tinted.

Examples of suitable polyolefins include, but are not limited to: polyethylenes; polypropylenes; poly(1-butene); poly(methyl pentene); poly(vinyl chloride); poly(acrylonitrile); poly(tetrafluoroethylene) (PTFE-Teflon®), poly(vinyl acetate); polystyrene; poly(methyl methacrylate, PMMA); ethylene-vinyl acetate copolymer; ethylene methyl acrylate copolymer; styrene-acrylonitrile copolymers; cycloolefin polymers and copolymers (COC); and mixtures and derivatives thereof.

Examples of suitable polyethylenes include, but are not limited to, low density polyethylene, linear low density polyethylene, high density polyethylene, ultra-high molecular weight polyethylene, and derivatives thereof.

Examples of suitable polyamides include nylon 6-6, nylon 6-12 and nylon 6.

Examples of suitable polyesters include polyethylene terephthalate, polybutylene terephthalate, polytrimethylene terephthalate, polyethylene adipate, polycaprolactone, and polylactic acid.

In some embodiments, the thermoplastic organic polymer is a polyolefin, in particular, a cyclo-olefin homopolymer or copolymer. In this specification the term “cycloolefin homopolymer” means a polymer formed entirely from cycloalkene (cycloolefin) monomers. Typically, the cycloalkene monomers from which the cycloolefin homopolymer is formed have 3 to 14, suitably 4 to 12, in some embodiments 5 to 8, ring carbon atoms. Typically, the cycloalkene monomers from which the cycloolefin homopolymer is formed have 1 to 5, such as 1 to 3, suitably 1 or 2, in some embodiments 1 carbon-carbon double bonds. Typically, the cycloalkene monomers from which the cycloolefin homopolymer is formed have 1 to 5, such as 1 to 3, suitably 1 or 2, in some embodiments 1 carbocyclic ring. The carbocyclic ring may be substituted with one or more, typically 1 to 3, suitably 1 or 2, in some embodiments 1 substituent, the substituent(s) being each independently selected from the group consisting of C₁₋₆ alkyl (typically C₁₋₄ alkyl, particularly methyl or ethyl), alkoxy, C₃₋₈ cycloalkyl (typically C₅₋₇ cycloalkyl, especially cyclopentyl or cyclohexyl), phenyl (optionally substituted by 1 to 5 substituents selected from C₁₋₆ alkyl, C₁₋₆ alkoxy, halo and nitro), or halogen.

The term “cycloolefin coopolymer” means a polymer formed from both cycloalkene and non-cyclic alkene (olefin) monomers. Typically, the cycloalkene monomers from which the cycloolefin copolymer is formed have 3 to 14, suitably 4 to 12, in some embodiments 5 to 8, ring carbon atoms. Typically, the cycloalkene monomers from which the cycloolefin coopolymer is formed have 1 to 5, such as 1 to 3, suitably 1 or 2, in some embodiments 1 carbon-carbon double bonds. Typically, the cycloalkene monomers from which the cycloolefin copolymer is formed have 1 to 3, suitably 1 or 2, in some embodiments 1 carbocyclic ring. The carbocyclic ring may be substituted with one or more, typically 1 to 3, suitably 1 or 2, in some embodiments 1 substituent, the substituent(s) being each independently selected from the group consisting of C₁₋₆ alkyl (typically C₁₋₄ alkyl, particularly methyl or ethyl), C₃₋₈ cycloalkyl, (typically C₅₋₇ cycloalkyl, especially cyclopentyl or cyclohexyl), alkoxy, phenyl (optionally substituted by 1 to 5 substituents selected from C₁₋₆ alkyl, C₁₋₆ alkoxy, halo and nitro), or halogen. Examples of the non-cyclic alkene monomers copolymerized with the cycloolefin monomer include ethylene; propylene; 1-butene; 2-methylpentene; vinyl chloride; acrylonitrile; tetrafluoroethylene; vinyl acetate; styrene; methyl methacrylate and methyl acrylate, in some embodiments ethylene or propylene, particularly ethylene.

Examples of commercially available cycloolefin homopolymers and copolymers usable in the present invention are those based on 8,8,10-trinorborn-2-ene (norbornene; bicyclo[2.2.1]hept-2-ene) or 1,2,3,4,4a,5,8,8a-octahydro-1,4:5,8-dimethanonapthalene (tetracyclododecene) as monomers. As described in Shin et al., Pure Appl. Chem., 2005, 77(5), 801-814⁶⁵, homopolymers of these monomers can be formed by a ring opening metathesis polymerization: copolymers are formed by chain copolymerization of the aforementioned monomers with ethylene.

An example of a ring opening metathesis polymerization scheme for norbornene derivatives, as well as a scheme for their copolymerization with ethene is shown below.

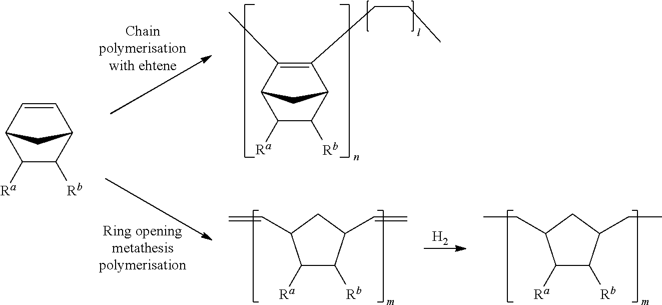

In the above reaction scheme, n, l and m are defined such that the average molecular weight (Mw) of the polymer ranges from 50,000 to 150,000.

Another class of materials known to be suitable for microfluidic device substrates is the class of silicone polymers polydimethylsiloxane (PDMS). These polymers have the general formula:

CH₃—[Si(CH₃)₂₋O]ₙ₋Si(CH₃)₃

where n is the number of repeating monomer [SiO(CH₃)₂] units.

In the above formula, n is such that the average molecular weight (Mw) of the polymer ranges from 100 to 100,000, in some embodiments 100 to 50,000.

Examples of copolymer types include: alternating copolymers (where the repeating A and B units alternate A-B-A-B-A-B); block copolymers which comprise two or more homopolymer subunits linked by covalent bonds (AAAAAAAA-BBBBBBBB-AAAAAAA-BBBBBBB) and random copolymers where the repeating A and B units are distributed randomly. In some embodiments, the copolymers used in the present invention are random copolymers.

Particularly preferred substrates are formed from poly(methyl methacrylate) (PMMA), polycarbonate (PC), poly(ethylene terephthalate) and/or cycloolefin copolymers (COC).

Examples of suitable poly(methyl methacrylate) can be obtained from Röhm, Darmstadt, Germany. Examples of suitable COC substrates are produced by Topas (e.g. Grade 5013, TOPAS Advanced polymers GmbH, Frankfurt, Germany).

In a preferred embodiment, the substrate is, or is at least, a poly(methyl methacrylate) substrate. In a preferred embodiment, the substrate is, or is at least, a cycloolefin copolymer substrate.

In a preferred embodiment, the methods of the present invention use a combination of substrates. In a preferred embodiment, the methods of the present invention use a combination of poly(methyl methacrylate) substrates and cycloolefin copolymer substrates.

Solvent Vapor

The present invention utilizes solvent vapor to bond two or more substrates and/or to decrease the surface roughness of the microfluidic channels formed in a substrate.

The solvent used as the source of the solvent vapor is limited only to the extent that it must be able to solubilize the substrate to a degree sufficient to enable bonding of two substrates and/or to decrease the roughness of the microfluidic channels. In this regard, it is known in the art that substrates vary in their susceptibility to solubilization by certain solvents. For example, it is known that cycloolefin copolymer polymers are generally susceptible to solubilization by non-polar solvents, such as chloroform, benzene and cyclohexane.

In order to determine whether a particular solvent is suitable to solubilize a particular polymer, the Hansen solubility parameter (HSP) of the solvent and substrate can be considered. Using this approach, it is possible to determine whether there will be a “match” between a substrate and a solvent and therefore whether the solvent will solubilize the substrate.

The Hansen solubility parameter uses a three-parameter approach which quantitatively describes the non-polar (atomic) interactions, dispersion interactions, E_{D}, permanent dipole-permanent dipole (molecular) interactions, E_{P}, and the hydrogen-bonding (molecular) interactions, E_{H}:

E=E_{D}+E_{P+}E_{H}

Hansen solubility parameter values can be obtained using Hansen Solubility Parameters: A user's handbook, Second Edition. Boca Raton, Fla.: CRC Press⁶³. A comparison of calculated and experimental solubility parameters is also given in Belmares et al, vol. 25, no. 15, Journal of Computational Chemistry, 2004⁶⁴.

Hansen et al, Ind. Eng. Chem. Res, 2001, 40, 21-25⁶², provides an explanation of the application of Hansen solubility parameters to stress cracking in plastics and COC in particular. Hansen solubility parameters can be readily measured for polymers. Accordingly, the skilled person is able to optimize which solvents can be used to effectively solubilize particular substrates.

In one embodiment, the solvent used in the presently invention may be a polar solvent or a non-polar solvent. In one embodiment, the solvent is a polar solvent. In one embodiment, the solvent is a non-polar solvent.

Non-limiting examples of polar solvents are dichloromethane (DCM), tetrahydrofuran (THF), ethyl acetate, acetone, dimethylformamide (DMF), acetonitrile, dimethyl sulfoxide (DMSO), methanol, ethanol, n-propanol, n-butanol, and acetone.

Non-limiting examples of non-polar solvents are toluene, benzene, cyclohexane, chloroform, diethyl ether, pentane, and cyclopentane.

In one embodiment, the solvent vapor used in the present invention is selected from toluene, trichloroethylene, carbon tetrachloride, chlorobenzene, chloroform, cyclohexane, benzene, o-dichlorobenzene, butyl acetate, methyl isobutyl ketone, methylene dichloride, ethylene dichloride, 1,1-dichloroethane, isopentylacetate, hexane, ethyl acetate, diethyl ether, 1,4-doxane, tetrahydrofuran, acetophenone, isophorone, nitrobenzene, 2-nitropropane, acetone, diacetone alcohol, methyl-2-pyrrolidone ethylene glycol monobutyl ether, cyclohexanol, nitroethane, ethylene glycol monoethyl ether, dimethylformamide, 1-butanol, γ-butyrolactone, ethylene glycol monomethyl ether, dimethyl sulfoxide, propylene carbonate, nitromethane, dipropylene glycol, ethanol, diethylene glycol, propylene glycol, methanol, ethanolamine, ethylene glycol, formamide, methylcyclohexane, decalin, water and combinations thereof.

In one embodiment, the solvent is a non-polar solvent selected from toluene, trichloroethylene, carbon tetrachloride, chlorobenzene, chloroform, cyclohexane, benzene, and o-dichlorobenzene. In one embodiment, the solvent is selected from chloroform and cyclohexane.

It will be appreciated that where a combination of different substrates is used, different solvents made be used to solubilize the respective substrate surface.

In one embodiment, the substrate used is selected from cycloolefin copolymer polymers and poly(methyl methacrylate) polymers, and the solvent used is a non-polar solvent.

In one embodiment, the substrate comprises cycloolefin copolymer polymers, and the solvent used is a non-polar solvent selected from toluene, trichloroethylene, carbon tetrachloride, chlorobenzene, chloroform, cyclohexane, benzene, and o-dichlorobenzene.

In one embodiment, the substrate is a poly(methyl methacrylate) polymer, and the solvent used is selected from toluene, trichloroethylene, carbon tetrachloride, chlorobenzene, chloroform, cyclohexane, benzene, and o-dichlorobenzene.

In one embodiment, the substrate comprises a cycloolefin copolymer polymer, and the solvent used is a cyclohexane. In one embodiment, the substrate is a poly(methyl methacrylate) polymer, and the solvent used is chloroform.

In one embodiment, the solvent used in the presently disclosed method is a blend of one or more of the above mentioned solvents.

Microfluidic Device Applications

The microstructured devices produced by the methods disclosed herein may be employed in a number of applications. For example, the microstructured devices produced according to the methods described herein may be used in digital (droplet-based) microfluidics, molecular assays (including PCR amplification chips and micro arrays for fluorescent in situ hybridization (FISH) detection of DNA/RNA sequences, liquid chromatography, protein analysis, cell separation, cell manipulation, cell culturing), microfluidic modular (bolt-on) components (for example pumps, valves, mixers etc.), adaptive landscape chips to study evolutionary biology, cellular biophysics chips, optofluidic devices, acoustics based microfluidic devices, microfluidic fuel cells, cytometers, continuous flow systems, stop flow systems, multiplexed stop flow systems, flow injection analysis, segmented flow analysis, fresh water analyzers, sea water analyzers, bio-fluid analyzers and medical analyzers.

Some known functions in droplet-based microfluidics are to:
1. form, create or produce one or more droplets on demand
2. sort droplets from a series
3. route droplets at a junction
4. coalesce or fuse two droplets to a combined droplet, e.g. to initiate or terminate a reaction
5. divide or split a droplet
6. induce mixing inside a droplet
7. sense passage of a droplet, or a certain kind of droplet passing down a channel
8. analyze one or more parameters of each droplet passing a sensor
9. electrically charge a droplet, e.g. to assist its future manipulation
10. electrically neutralize (discharge) a droplet

Many if not all these functions may be controlled by application or detection of electromagnetic fields, in particular electric fields, but also magnetic fields.

The coalescing function is important, since it is typically the basis under which the main activity of the device is performed. It is typical to coalesce droplets from different streams, e.g. sample and reagent, to form a coalesced droplet in which a chemical or biological reaction takes place. Such a combined droplet is sometimes referred to in the art as a nanoreactor, not just when in the nanometer scale, but even when in the micrometer scale.

Actuating or sensing electrodes may be arranged in, or to extend into, the flow channels to contact the fluid, or may be arranged outside the flow channels, adjacent thereto, so there is an insulating medium, e.g. the substrate material and/or air, between the electrode(s) and the droplet-containing carrier liquid.

The term actuating electrodes is used to refer to electrodes of an active component, whereas the term sensing electrode is used to refer to electrodes in a passive component.

For actuating electrodes, the magnitude of the electric field created in the flow channel is typically of the order of 10⁶-10⁸ V/m.

A number of known functions induced by electric field based active components are as follows:
1. charging droplets by applying an electric field via adjacent electrodes connected to a voltage source or current source
2. dividing a droplet into two droplets by inducing a dipole moment by applying an electric field via adjacent electrodes connected to a voltage source or current source which causes oppositely charged ions to move in opposed directions and therefore induces the droplet to split.
3. coalescing two droplets into one by inducing a dipole moment by applying an electric field via adjacent electrodes connected to a voltage source or current source which mutually attracts the two droplets and transiently forms a bridge through which the fusing is initiated.
4. urging or moving a droplet by an electric force induced by an applied electric field in the direction of the channel, or at least having an electric field component in the direction of the channel. This may be used to direct a droplet down a particular leg of a bifurcation, for example to sort droplets with 2 or more distinct properties, or to route a droplet stream for a period of time.
5. removing charge from droplets (neutralizing) by moving the droplets past a ground electrode arranged closely adjacent the channel or in the channel

Passive components may be fabricated from conductive patterning in which electric or magnetic fields are induced by the passage of droplets (inductive loop detector). The usual range of components known from radio frequency (RF) device fabrication may be used, including inductive, resistive and capacitive elements, and combinations thereof.

A simple passive component would be an electrode pair either side of a channel connected to form a sensing circuit including the channel, wherein the resistance would be affected, typically decreased, when a droplet passes the electrode pair.

Electrically conductive patterning may be used to fabricate electromagnetic sensors to integrate with the microfluidic device, such as a Hall sensor, which for example might be useful if the droplets were associated with magnetic beads. Another sensor type which can be used for sensing the passage of droplets is an antenna structure such as a bowtie antenna.

An electrode may extend substantially at right angles to the flow channel and terminate a small distance away from the flow channel edge, or at the flow channel edge, or in the flow channel, or may extend right through the flow channel. For example, a pair of electrodes can be provided both extending substantially at right angles to each other and terminating opposed to each other on either side of the flow channel.

Other electrodes may extend in the flow channel direction and either be located in the flow channel or adjacent the flow channel. For example, a pair of electrodes may be arranged to extend parallel to a channel on either side of the channel for a section of the channel so that an electric field may be applied transverse to the flow direction over the section of the flow channel.

A wide range of droplet diameter is also envisages including the nanometer range, in particular 100-1000 nanometers, as well as 1-1000 micrometers, in particular 1-100 micrometers.

The carrier liquid may be an oil. The droplet liquid may be an aqueous solution, e.g. containing an enzyme, or an alcohol solution, or an oil solution.

It will be understood that further embodiments may combine the previously discussed embodiments.

### EXAMPLES

The present invention will now be described with reference to the following non-limiting examples.

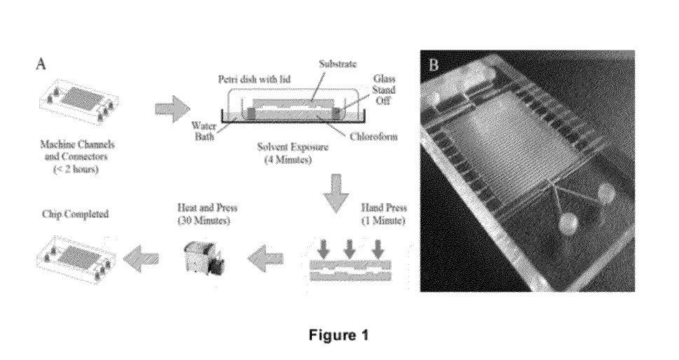

1.1 General Bonding of Two poly(methyl methacrylate) (PMMA) Polymer Substrates (Schematically shown in FIG. 1)

Fabrication

PMMA sheets (thicknesses from 1.5 mm to 8 mm) were obtained from (Röhm, Darmstadt, Germany). Channels were fabricated and ports/threads for MINSTAC microfluidic connectors (The Lee Company, Connecticut, USA) were machined into the plastics prior to bonding. The design was created using Circuitcam software (LPKF laser and electronics AG, Garbsen, Germany), software which calculates tool paths. This data was then imported into BoardMaster software (LPKF) which controls an automated LPKF Protomat S100 micro-mill (LPKF Laser and Electronics AG, Garbsen, Germany) which was used to mill channels and cut out the substrates.

Solvent Bonding

For solvent bonding, the two halves were aligned using a custom made jig which had a series of pins set in perpendicular rows. Both structures were pushed into a corner and pressed together to secure them (see FIG. 1). This provided an alignment accuracy of typically 20 μm.

Prior to exposure to solvent vapor, the substrates were thoroughly cleaned with detergent, and then rinsed in deionized water in an ultrasonic bath. Substrates were subsequently rinsed in isopropanol followed by ethanol, and dried with nitrogen.

Solvent vapor exposure was performed by suspending the substrates above a bath of solvent in a 100 mm diameter glass Petri dish with lid. Four glass stand-offs 6 mm high were placed in the Petri dish and approximately 30 ml of chloroform added to bring the level to within 2 mm of the top of the standoffs. The substrates are placed on top of the standoffs and the lid placed over the whole assembly. The temperature of the assembly was controlled to 25° C. using a water bath. After 4 minutes of exposure the substrates were carefully removed.

The parts were aligned using a jig with pins set in perpendicular rows and pressed together by hand to partially bond the substrates. They were then transferred to a hot press (LPKF Multipress) pre-heated to 65° C. with a pressure of 140 Ncm⁻² for 20 minutes, then actively cooled to room temperature over 10 minutes.

The chips were removed from the press and left to settle for 12 hours, improving bond strength by allowing excess solvent to migrate out of the substrates.

1.2 Bonding of Two poly(methyl methacrylate) (PMMA) Polymer Substrates

The general procedure for preparing and bonding the two substrates was the same as described in Example 1.1. Additional specific steps are described below as well as specific parameters for clear PMMA and tinted PMMA (Plexiglass GS 7F61)⁶⁶ respectively.

1. Gather PMMA substrates with either micro-machined (SOP micromilling) or embossed surface features.

2. Preheat press to 65° C. with plates loaded in machine.

3. Clean and degrease both substrates: with a cloth soaked in detergent, scrub the substrate vigorously for 1 minute and rinse with tap water; sonicate for 5 minutes (SOP Sonication); with a cloth soaked in detergent, scrub the substrate vigorously for 1 minutes and rinse with tap water; spray rinse with IPA for 10-20 seconds; spray rinse with ethanol for 10-20 seconds; dry by shaking in air, cleaning with fiber free cloth, or applying pressurized nitrogen.

4. Prepare a solvent vapor chamber as in Example 1.1.

5. Place both substrates feature side down on top of the supports. In this way, the substrates are suspended above the chloroform and can be easily manipulated.

6. Using a transfer pipette or pouring directly from the bottle, add approx. 30 ml of Chloroform to the glass dish. The liquid Chloroform should come within approximately 1 mm to the top of the supports.

7. Put lid on top and leave the substrate in the chloroform atmosphere for 4 minutes for clear PMMA, 4 min 15 seconds for tinted PMMA.

8. Remove the substrates from the chloroform atmosphere and place on wipes (keep out of direct sunlight).

9. Align and push substrates together by hand to pre-bond them.

10. Place substrates in LPKF press and apply pressure.

11. Remove bonded substrates from press and characterize bonding strength and surface roughness.

With regard to step 10, for clear PMMA, the following substrate bonding settings were used on the LPKF MultiPress:

| | | |
|---|---|---|
| Pre-heat Temperature | 60° | C. |
| Pre-press Temperature | 65° | C. |
| Pre-press Pressure | 80 | Ncm⁻² |
| Pre-press Time | 1 | min |
| Main-press Temperature | 65° | C. |
| Main-press Pressure | 160 | Ncm⁻² |
| Main-press Time | 20 | min |

With regard to step 10, for tinted PMMA, the following substrate bonding settings were used on the LPKF MultiPress:

| | | |
|---|---|---|
| Pre-heat Temperature | 65° | C. |
| Pre-press Temperature | 85° | C. |
| Pre-press Pressure | 180 | Ncm⁻² |
| Pre-press Time | 15 | min |
| Main-press Temperature | 80° | C. |
| Main-press Pressure | 180 | Ncm⁻² |
| Main-press Time | 120 | min |

1.3 Bonding of Two cycloolefin copolymer (COC) Polymer Substrates

The general procedure was the same as described in Example 1.1, with the following modifications.

Fabrication

Cyclic-olefin copolymer (COC) wafers (0.7 mm and 1.2 mm) were obtained from Topas (Grade 5013, TOPAS Advanced polymers GmbH, Frankfurt, Germany)

Solvent Bonding

Cyclohexane was used as the solvent.

2.1 Analysis of Substrate Bonding

The bond strength was characterized with an ASTM D1876 T-Peel test using an Instron 5569 tensile testing machine (Instron, Buckinghamshire, UK⁶⁷).

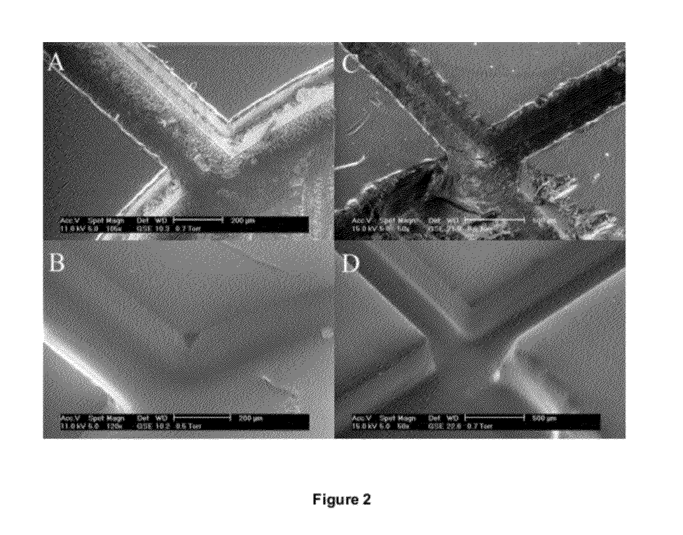

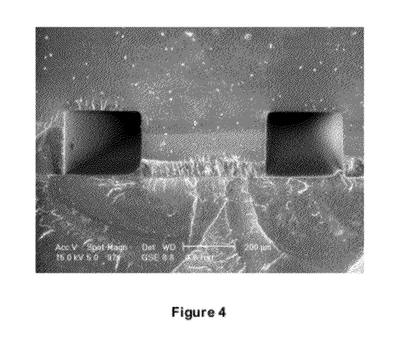

FIG. 4 shows an example of the channel cross-section for a PMMA bonded chip. The channels are the same dimensions as in FIG. 2, 250 μm wide and 200 μm deep. The final bonded structure shows little deformation and the bonded region is not visible in the cross section. The fractures that appear in this image are not from the bond, but from the process used to cross-section the wafer. The small lips on the inside corners of the channels on the right hand side occur because of small shifts in one half relative to the other during the bonding process.

The bond strength was measured from the peak peel force required for delamination.

FIG. 5 shows a summary of the force as a function of time of exposure to solvent (at 140 Ncm⁻²) and pressure (for 4 minutes exposure) during bonding. For PMMA, the data shows that the bond pressure has little influence on the bond strength.

For Topas 5013 COC, bond pressure has a more significant effect on bond strength. This may be due to variations in the quality of the Topas 5013 COC wafers or migration of the separate polymer species during solvent exposure for PGMA-PMMA copolymers³⁹.

The data shows that a high pressure produces a stronger bond, but for the 250 μm channels used in this work, the optimum pressure without channel distortion was found to be 140 Ncm⁻².

Bonding of other grades of COC was attempted and it was found that the optimum solvent vapor exposure time varied depending on the grade of COC.

3.1 Analysis of Surface Roughness of Microfluidic Channels

After micromilling and solvent exposure, the microfluidic channels were examined using Atomic Force Microscope and Scanning Electron Microscopy.

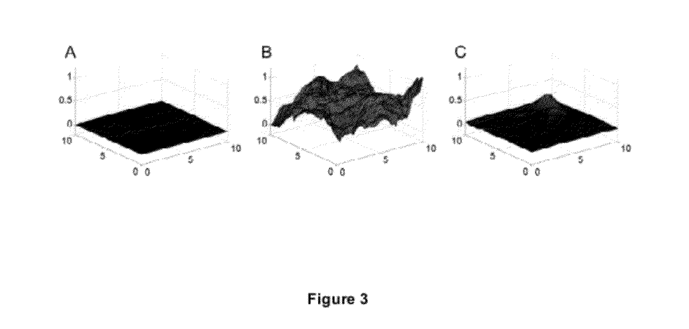

FIG. 2 shows an SEM of a microfluidic channel milled in PMMA and COC immediately after machining, showing the typical quality obtained with a micro-mill. After milling the typical surface roughness was 100-200 nm measured using atomic force microscopy (AFM) (FIG. 3).

Following solvent vapor exposure the surface roughness was reduced substantially to typically less than 15 nm, close to the quality of the virgin wafers (<5 nm). When only a temperature cycle was performed (i.e. milling then a heat cycle with no solvent exposure), the surface roughness was reduced from 100-200 nm to 70 nm, indicating that the surface smoothing was predominantly from exposure to the solvent vapor.

FIGS. 2(B and D) show SEMs of the treated surfaces and the AFM surface roughness data is summarized in FIG. 3. The reduction in surface roughness is significant and returns the material surface close to the virgin quality.

3.2 Further Characterization of Surface Roughness by Observing Light Scattering through a Planar Cylindrical Micro-Lens

To further evaluate the surface finish of the polymers, a planar cylindrical micro-lens (radius of 150 μm), was micro-milled. This lens was used to collimate light across a microfluidic channel.

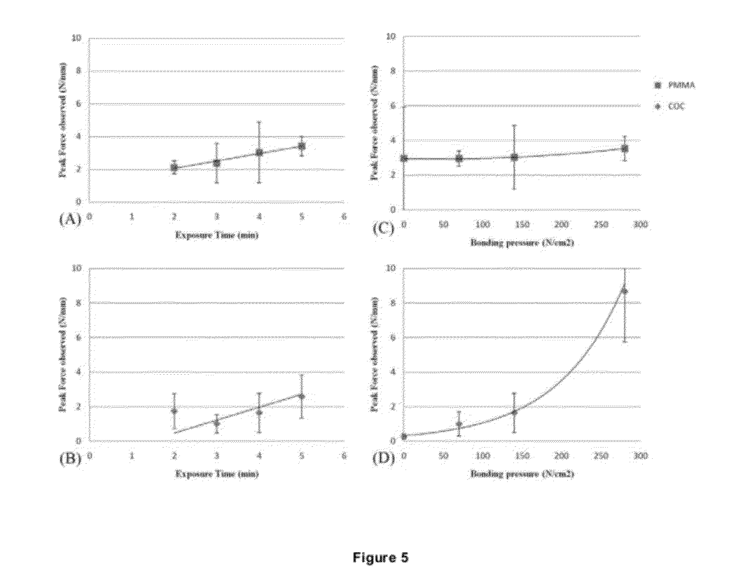

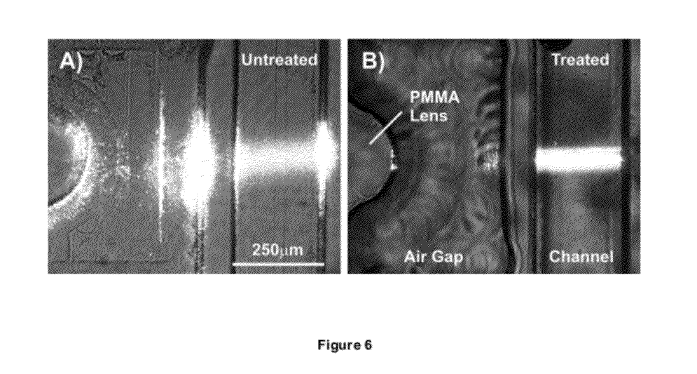

FIG. 6 shows a photograph of a milled PMMA microchip with a cylindrical lens. The channel was 250 μm deep and 250 μm wide. Light was launched into the microchip via a Thorlabs HPSC 10 fiber (10 micrometer core, 0.11 N.A. silica fibre) coupled to a laser diode; 640 nm, 45 mW (LDCU 12/9145, Powertechnology, Ariz., USA). To observe the light, the channel was filled with deionized water and 200 nm silica particles (PSi-0.2, Kisker-Biotech, Steinfurt, Germany) at a concentration of 0.5 mg/ml (100-fold dilution).

FIG. 6(A) shows the microchip after micro-milling and before solvent vapor treatment; the lens is ineffective as shown by the degree of light scattering at the interfaces and the degradation of the beam profile across the channel. FIG. 6(B) shows the improvement of the lens performance after solvent vapor treatment. Both Figure images (6(A) and (B)) were acquired with identical camera exposure times and settings.

All publications mentioned in the above specification are herein incorporated by reference. Various modifications and variations of the described methods and system of the present invention will be apparent to those skilled in the art without departing from the scope and spirit of the present invention. Although the present invention has been described in connection with specific preferred embodiments, it should be understood that the invention as claimed should not be unduly limited to such specific embodiments. Indeed, various modifications of the described modes for carrying out the invention which are obvious to those skilled in chemistry, physics and materials science or related fields are intended to be within the scope of the following claims.

### REFERENCES

1. A. Manz, N. Graber and H. M. Widmer, Sensors and Actuators B-Chemical, 1990, 1, 244-248.

2. P. S. Dittrich, K. Tachikawa and A. Manz, Anal. Chem., 2006, 78, 3887-3908.

3. H. F. Li and J. M. Lin, Anal. Bioanal. Chem., 2009, 393, 555-567.

4. L. Marle and G. M. Greenway, Trac-Trends Anal. Chem., 2005, 24, 795-802.

5. R. R. Hood, K. E. Kohler, J. P. McCreary and S. L. Smith, Deep-Sea Res. Part II-Top. Stud. Oceanogr., 2003, 50, 2917-2945.

6. M. A. M. Friedrichs, J. A. Dusenberry, L. A. Anderson, R. A. Armstrong, F. Chai, J. R. Christian, S. C. Doney, J. Dunne, M. Fujii, R. Hood, D. J. McGillicuddy, J. K. Moore, M. Schartau, Y. H. Spitz and J. D. Wiggert, J. Geophys. Res.-Oceans, 2007, 112, 22.

7. H. W. Ducklow, S. C. Doney and D. K. Steinberg, Annu. Rev. Mar. Sci., 2009, 1, 279-302.

8. P. Brasseur, N. Gruber, R. Barciela, K. Brander, M. Doron, A. El Moussaoui, A. J. Hobday, M. Huret, A. S. Kremeur, P. Lehodey, R. Matear, C. Moulin, R. Murtugudde, I. Senina and E. Svendsen, Oceanography, 2009, 22, 206-215.

9. T. L. Delworth, A. J. Broccoli, A. Rosati, R. J. Stouffer, V. Balaji, J. A. Beesley, W. F. Cooke, K. W. Dixon, J. Dunne, K. A. Dunne, J. W. Durachta, K. L. Findell, P. Ginoux, A. Gnanadesikan, C. T. Gordon, S. M. Griffies, R. Gudgel, M. J. Harrison, I. M. Held, R. S. Hemler, L. W. Horowitz, S. A. Klein, T. R. Knutson, P. J. Kushner, A. R. Langenhorst, H. C. Lee, S. J. Lin, J. Lu, S. L. Malyshev, P. C. D. Milly, V. Ramaswamy, J. Russell, M. D. Schwarzkopf, E. Shevliakova, J. J. Sirutis, M. J. Spelman, W. F. Stern, M. Winton, A. T. Wittenberg, B. Wyman, F. Zeng and R. Zhang, J. Clim., 2006, 19, 643-674.

10. K. S. Johnson, W. M. Berelson, E. S. Boss, Z. Chase, H. Claustre, S. R. Emerson, N. Gruber, A. Kortzinger, M. J. Perry and S. C. Riser, Oceanography, 2009, 22, 216-225.

11. P. Griess, Berichte der deutschen chemischen Gesellschaft, 1879, 12, 426-428.

12. W. R. G. Atkins, Journal of the Marine Biological Association of the United Kingdom, 1923, 13, 119-150.

13. L. L. Stookey, Anal. Chem., 1970, 42, 779-&.

14. C. S. Chin, K. S. Johnson and K. H. Coale, Marine Chemistry, 1992, 37, 65-82.

15. K. Grasshoff, K. Kremling and M. Ehrhardt, Methods of Seawater Analysis (Third Edition), Wiley-VCH, Weinheim (Federal Republic of Germany), 1999.

16. F. A. J. Armstrong, C. R. Stearns and J. D. H. Strickland, Deep Sea Res, 1967, 14, 381-389.

17. A. K. Hanson, OCEANS 2000 MTS/IEEE Conference and Exhibition, 2000.

18. D. Thouron, R. Vuillemin, X. Philippon, A. Lourenco, C. Provost, A. Cruzado and V. Garcon, Anal. Chem., 2003, 75, 2601-2609.

19. L. R. Adornato, E. A. Kaltenbacher, T. A. Villareal and R. H. Byrne, Deep Sea Research Part I: Oceanographic Research Papers, 2005, 52, 543-551.

20. M. D. Patey, M. J. A. Rijkenberg, P. J. Statham, M. C. Stinchcombe, E. P. Achterberg and M. Mowlem, Trac-Trends Anal. Chem., 2008, 27, 169-182.

21. Becker H and Heim U 2000 Hot embossing as a method for the fabrication of polymer high aspect ratio structures Sensors and Actuators A: Physical 83 130-5

22. Kricka L J, Fortina P, Panaro N J, Wilding P, Alonso-Amigo G and Becker H 2002 Fabrication of plastic microchips by hot embossing Lab Chip 2 1-4

23. Studer V, Pepin A and Chen Y 2002 Nanoembossing of thermoplastic polymers for microfluidic applications Appl. Phys. Lett. 80 3614-6

24. Steigert J et al 2007 Rapid prototyping of microfluidic chips in COC J. Micromech. Microeng. 17 333-41

25. Becker H and Gartner C 2000 Polymer microfabrication methods for microfluidic analytical applications Electrophoresis 21 12-26

26. Qi S et al 2002 Microfluidic devices fabricated in poly(methyl methacrylate) using hot-embossing with integrated sampling capillary and fiber optics for fluorescence detection Lab Chip 2 88-95

27. Effenhauser C S, Bruin G J M, Paulus A and Ehrat M 1997 Integrated capillary electrophoresis on flexible silicone microdevices: Analysis of DNA restriction fragments and detection of single DNA molecules on microchips Anal. Chem. 69 3451-7

28. Kaigala G V, Ho S, Penterman R and Backhouse C J 2007 Rapid prototyping of microfluidic devices with a wax printer Lab Chip 7 384-7

29. Tse L A, Hesketh P J, Rosen D W and Gole J L 2003 Stereolithography on silicon for microfluidics and microsensor packaging Microsystem Technologies 9 319-23

30. Friedrich C R and Vasile M J 1996 Development of the micromilling process for high-aspect-ratio microstructures Journal of Microelectromechanical Systems 5 33-8

31. Heng Q, Tao C and Tie-chuan Z 2006 Surface roughness analysis and improvement of micro-fluidic channel with excimer laser Microfluid. Nanofluid. 2 357-60

32. Bundgaard F, Nielsen T, Nilsson D, Shi P X, Perozziello G, Kristensen A and Geschke O 2004 Cyclic olefin copolymer (COC/Topas)—An exceptional material for exceptional lab-on-a-chip systems Micro Total Analysis Systems 2 372-4

33. Vulto P et al 2005 Microfluidic channel fabrication in dry film resist for production and prototyping of hybrid chips Lab Chip 5 158-62

34. Grimes A, Breslauer D N, Long M, Pegan J, Lee L P and Khine M 2008 Shrinky-Dink microfluidics: rapid generation of deep and rounded patterns Lab Chip 8 170-2

35. Bundgaard F, Perozziello G and Geschke O 2006 Rapid prototyping tools and methods for all-Topas (R) cyclic olefin copolymer fluidic microsystems Proceedings of the Institution of Mechanical Engineers Part C-Journal of Mechanical Engineering Science 220 1625-32

36. Yan J, Uchida K, Yoshihara N and Kuriyagawa T 2009 Fabrication of micro end mills by wire EDM and some micro cutting tests J. Micromech. Microeng. 19 025004

37. Bertsch A, Lorenz H and Renaud P 1999 3D microfabrication by combining microstereolithography and thick resist UV lithography Sensors and Actuators A: Physical 73 14-23

38. Lee K and Donfeld D A 2004 A Study of Surface Roughness in the Micro-End-Milling Process Research Reports 2003/04, Laboratory for Manufacturing Automation.(Berkeley: University of California) pp 44-51

39. Prokhorova S A, Kopyshev A, Ramakrishnan A, Zhang H and Ruhe J 2003 Can polymer brushes induce motion of nano-objects? Nanotechnology 14 1098-108

40. Tsao C W and DeVoe D L 2009 Bonding of thermoplastic polymer microfluidics Microfluid. Nanofluid. 6 1-16

41. Martynova L, Locascio L E, Gaitan M, Kramer G W, Christensen R G and MacCrehan W A 1997 Fabrication of plastic microfluid channels by imprinting methods Anal. Chem. 69 4783-9

42. Sung W C, Lee G B, Tzeng C C and Chen S H 2001 Plastic microchip electrophoresis for genetic screening: The analysis of polymerase chain reactions products of fragile X (CGG)n alleles Electrophoresis 22 1188-93

43. Lei K F, Ahsan S, Budraa N, Li W J and Mai J D 2004 Microwave bonding of polymer-based substrates for potential encapsulated micro/nanofluidic device fabrication Sens. Actuator A-Phys. 114 340-6

44. Chen Z F, Gao Y H, Lin J M, Su R G and Xie Y 2004 Vacuum-assisted thermal bonding of plastic capillary electrophoresis microchip imprinted with stainless steel template J. Chromatogr. A 1038 239-45

45. Yussuf A A, Sbarski I, Hayes J P, Solomon M and Tran N 2005 Microwave welding of polymeric-microfluidic devices J. Micromech. Microeng. 15 1692-9

46. Wallow T I, Morales A M, Simmons B A, Hunter M C, Krafcik K L, Domeier L A, Sickafoose S M, Patel K D and Gardea A 2007 Low-distortion, high-strength bonding of thermoplastic microfluidic devices employing case-II diffusion-mediated permeant activation Lab Chip 7 1825-31

47. Koesdjojo M T, Tennico Y H and Remcho V T 2008 Fabrication of a Microfluidic System for Capillary Electrophoresis Using a Two-Stage Embossing Technique and Solvent Welding on Poly(methyl methacrylate) with Water as a Sacrificial Layer Anal. Chem. 80 2311-8

48. Hsu Y-C and Chen T-Y 2007 Applying Taguchi methods for solvent-assisted PMMA bonding technique for static and dynamic μ-TAS devices Biomed. Microdevices 9 513-22

49. Shah J J, Geist J, Locascio L E, Gaitan M, Rao M V and Vreeland W N 2006 Capillarity Induced Solvent-Actuated Bonding of Polymeric Microfluidic Devices Anal. Chem. 78 3348-53

50. Klank H, Kutter J P and Geschke O 2002 CO2-laser micromachining and back-end processing for rapid production of PMMA-based microfluidic systems Lab Chip 2 242-6

51. Koesdjojo M T, Koch C R and Remcho V T 2009 Technique for Microfabrication of Polymeric-Based Microchips from an SU-8 Master with Temperature-Assisted Vaporized Organic Solvent Bonding Anal. Chem. 81 1652-9

52. Sun X, Peeni B A, Yang W, Becerril H A and Woolley A T 2007 Rapid prototyping of poly(methyl methacrylate) microfluidic systems using solvent imprinting and bonding J. Chromatogr. A 1162 162-6

53. Kelly R T, Pan T and Woolley A T 2005 Phase-Changing Sacrificial Materials for Solvent Bonding of High-Performance Polymeric Capillary Electrophoresis Microchips Anal. Chem. 77 3536-41

54. Griebel A, Rund S, Schonfeld F, Dorner W, Konrad R and Hardt S 2004 Integrated polymer chip for two-dimensional capillary gel electrophoresis Lab Chip 4 18-23

55. Brown L, Koerner T, Horton J H and Oleschuk R D 2006 Fabrication and characterization of poly(methylmethacrylate) microfluidic devices bonded using surface modifications and solvents Lab Chip 6 66-73

56. Ng S, Tjeung R, Wang Z, Lu A, Rodriguez I and de Rooij N 2008 Thermally activated solvent bonding of polymers Microsystem Technologies 14 753-9

57. Mair D A, Rolandi M, Snauko M, Noroski R, Svec F and Frechet J M J 2007 Room-Temperature Bonding for Plastic High-Pressure Microfluidic Chips Anal. Chem. 79 5097-102

58. Sauer-Budge A F, Mirer P, Chatterjee A, Klapperich C M, Chargin D and Sharon A 2009 Low cost and manufacturable complete microTAS for detecting bacteria Lab Chip 9 2803-10

59. Ro K W, Liu J and Knapp D R 2006 Plastic microchip liquid chromatography-matrix-assisted laser desorption/ionization mass spectrometry using monolithic columns J. Chromatogr. A 1111 40-7

60. Liu J, Ro K-W, Nayak R and Knapp D R 2007 Monolithic column plastic microfluidic device for peptide analysis using electrospray from a channel opening on the edge of the device International Journal of Mass Spectrometry 259 65-72

61. Lin C-H, Chao C-H and Lan C-W 2007 Low azeotropic solvent for bonding of PMMA microfluidic devices Sensors and Actuators B: Chemical 121 698-705

62. Hansen C M and Just L 2001 Prediction of environmental stress cracking in plastics with Hansen solubility parameters Ind. Eng. Chem. Res. 40 21-5

63. Hansen Solubility Parameters: A user's handbook, Second Edition. Boca Raton, Fla.: CRC Press.

64. Belmares et al, vol. 25, no. 15, Journal of Computational Chemistry, 2004.

65. Shin et al., Pure Appl. Chem., 2005, 77(5), 801-814

66. Evonik Industries (www.plexiglas.net) 2008 Plexiglas GS and Plexiglas XT Product Description Datasheet pp 1-8

67. ASTM Standard D1876. Standard Test Method for Peel Resistance of Adhesives (T-Peel Test). Vol. 15.06. 2008: ASTM International, West Conshohocken, Pa., www.astm.org.

What is claimed is:

1. A method of making a microstructured device comprising the steps of:
i) providing a first substrate with a first bonding surface and a second substrate with a second bonding surface, wherein at least one of the bonding surfaces is formed with microstructured features;
ii) exposing at least one of the bonding surfaces to a vapor of a solvent for a period of at least about 220 seconds;
iii) bringing the first and second bonding surfaces into contact; and
iv) applying pressure to the substrates to urge the first and second bonding surfaces together to bond together the first and second substrates and thereby form the microstructured device.

2. The method of claim 1, wherein at least one of the first and second substrates is made of a thermoplastic polymer selected from the group consisting of polyethylenes; polypropylenes; poly(1-butene); poly(methyl pentene); poly(vinyl chloride); poly(acrylonitrile); poly(tetrafluoroethylene) (PTFE-Teflon®), poly(vinyl acetate); polystyrene; poly(methyl methacrylate) (PMMA); ethylene-vinyl acetate copolymer; ethylene methyl acrylate copolymer; styrene-acrylonitrile copolymers; cycloolefin polymers and copolymers (COC); and mixtures and derivatives thereof.

3. The method of claim 1, wherein at least one of the first and second substrates is made of poly(methyl methacrylate) (PMMA) or cycloolefin polymers and copolymers (COC).

4. The method of claim 1, wherein at least one of the first and second substrates is made of a material which the vapor of the solvent is capable of solubilizing.

5. The method of claim 1, wherein the solvent is selected from the group consisting of toluene, trichloroethylene, carbon tetrachloride, chlorobenzene, chloroform, cyclohexane, benzene, o-dichlorobenzene, butyl acetate, methyl isobutyl ketone, methylene dichloride, ethylene dichloride, 1,1-dichloroethane, isopentylacetate, hexane, ethyl acetate, diethyl ether, 1,4-doxane, tetrahydrofuran, acetophenone, isophorone, nitrobenzene, 2-nitropropane, acetone, diacetone alcohol, methyl-2-pyrrolidone ethylene glycol monobutyl ether, cyclohexanol, nitroethane, ethylene glycol monoethyl ether, dimethylformamide, 1-butanol, γ-butyrolactone, ethylene glycol monomethyl ether, dimethyl sulfoxide, propylene carbonate, nitromethane, dipropylene glycol, ethanol, diethylene glycol, propylene glycol, methanol, ethanolamine, ethylene glycol, formamide, methylcyclohexane, decalin, water and combinations thereof.

6. The method of claim 1, wherein at least one of the first and second substrates is made of poly(methyl methacrylate) (PMMA) and the solvent is chloroform.

7. The method of claim 1, wherein at least one of the first and second substrates is made of cycloolefin polymers and copolymers (COC) and the solvent is cyclohexane.

8. The method of claim 1, wherein the first substrate is made of a thermoplastic polymer and the second substrate is made of said thermoplastic polymer or a further thermoplastic polymer.

9. The method of claim 1, wherein said exposing takes place for a period of time in the range of about 220 seconds to about ten minutes.

10. The method of claim 1, wherein said at least one of the bonding surfaces formed with microstructured features has a magnitude of surface roughness in the region of 50 nm to 250 nm prior to said exposing which reduces to less than 25 nm as a result of said exposing.

11. A method of making a microstructured device comprising the steps of:
i) providing a first substrate with a first bonding surface and a second substrate with a second bonding surface, wherein at least one of the bonding surfaces is formed with microstructured features;
ii) exposing at least one of the bonding surfaces to solvent vapor for a period of time sufficient to heal defects in the surface while preserving the microstructured features.;
iii) bringing the first and second bonding surfaces into contact; and
iv) applying pressure to the substrates to urge the first and second bonding surfaces together to bond together the first and second substrates and thereby form the microstructured device.

12. The method of claim 11, wherein at least one of the first and second substrates is made of a thermoplastic polymer selected from the group consisting of polyethylenes; polypropylenes; poly(1-butene); poly(methyl pentene); poly(vinyl chloride); poly(acrylonitrile); poly(tetrafluoroethylene) (PTFE-Teflon®), poly(vinyl acetate); polystyrene; poly(methyl methacrylate) (PMMA); ethylene-vinyl acetate copolymer; ethylene methyl acrylate copolymer; styrene-acrylonitrile copolymers; cycloolefin polymers and copolymers (COC); and mixtures and derivatives thereof.

13. The method of claim 11, wherein at least one of the first and second substrates is made of poly(methyl methacrylate) (PMMA) or cycloolefin polymers and copolymers (COC).

14. The method of claim 11, wherein at least one of the first and second substrates is made of a material which the vapor of the solvent is capable of solubilizing.

15. The method of claim 11, wherein the solvent is selected from the group consisting of toluene, trichloroethylene, carbon tetrachloride, chlorobenzene, chloroform, cyclohexane, benzene, o-dichlorobenzene, butyl acetate, methyl isobutyl ketone, methylene dichloride, ethylene dichloride, 1,1-dichloroethane, isopentylacetate, hexane, ethyl acetate, diethyl ether, 1,4-doxane, tetrahydrofuran, acetophenone, isophorone, nitrobenzene, 2-nitropropane, acetone, diacetone alcohol, methyl-2-pyrrolidone ethylene glycol monobutyl ether, cyclohexanol, nitroethane, ethylene glycol monoethyl ether, dimethylformamide, 1-butanol, γ-butyrolactone, ethylene glycol monomethyl ether, dimethyl sulfoxide, propylene carbonate, nitromethane, dipropylene glycol, ethanol, diethylene glycol, propylene glycol, methanol, ethanolamine, ethylene glycol, formamide, methylcyclohexane, decalin, water and combinations thereof.

16. The method of claim 11, wherein at least one of the first and second substrates is made of poly(methyl methacrylate) (PMMA) and the solvent is chloroform.

17. The method of claim 11, wherein at least one of the first and second substrates is made of cycloolefin polymers and copolymers (COC) and the solvent is cyclohexane.

18. The method of claim 11, wherein the first substrate is made of a thermoplastic polymer and the second substrate is made of said thermoplastic polymer or a further thermoplastic polymer.

19. The method of claim 11, wherein said exposing takes place for a period of time in the range of about 220 seconds to about 280 seconds.

20. The method of claim 11, wherein said at least one of the bonding surfaces formed with microstructured features has a magnitude of surface roughness in the region of 50 nm to 250 nm prior to said exposing which reduces to less than 25 nm as a result of said exposing.

21. A method of processing a microstructured substrate to heal surface defects therein, comprising the step of:
i) providing a substrate having a surface bearing microstructured features;
ii) exposing said surface to solvent vapor for a period of time sufficient to heal defects in the surface while preserving the microstructured features.

22. The method of claim 21, wherein said surface has a magnitude of surface roughness in the region of 50 nm to 250 nm prior to said exposing which reduces to less than 25 nm as a result of said exposing.

23. A microstructured device produced by the method of:
i) providing a first substrate with a first bonding surface and a second substrate with a second bonding surface, wherein at least one of the bonding surfaces is formed with microstructured features;
ii) exposing at least one of the bonding surfaces to a vapor of a solvent for a period of at least about 220 seconds;
iii) bringing the first and second bonding surfaces into contact; and
iv) applying pressure to the substrates to urge the first and second bonding surfaces together to bond together the first and second substrates.

24. A microstructured device produced by the method of:
i) providing a first substrate with a first bonding surface and a second substrate with a second bonding surface, wherein at least one of the bonding surfaces is formed with microstructured features;
ii) exposing at least one of the bonding surfaces to solvent vapor for a period of time sufficient to heal defects in the surface while preserving the microstructured features;
iii) bringing the first and second bonding surfaces into contact; and
iv) applying pressure to the substrates to urge the first and second bonding surfaces together to bond together the first and second substrates.
